(19) United States
(12) Patent Application Publication
(10) Pub. No.: US 2009/0315618 A1
(43) Pub. Date: Dec. 24, 2009

(54) CURRENT MIRROR CIRCUIT

(75) Inventor: Fuminori Hashimoto, Saitama-ken (JP)

Correspondence Address: OSHA LIANG L.L.P., TWO HOUSTON CENTER, 909 FANNIN, SUITE 3500, HOUSTON, TX, 77010, US

(73) Assignees: SANYO ELECTRIC CO., LTD., Moriguchi-shi, Osaka (JP); SANYO SEMICONDUCTOR CO., LTD., Gunma (JP)

(21) Appl. No.: 12/376,133

(22) PCT Filed: Dec. 17, 2007
(86) PCT No.: PCT/JP2007/074229

§ 371 Date: Feb. 3, 2009

(30) Foreign Application Priority Data
Dec. 27, 2006 (JP) 2006-351119

(51) Int. Cl. G05F 3/02

(52) U.S. Cl. 327/543

(57) ABSTRACT

A current mirror circuit includes a first transistor, a plurality of second transistors whose bases are connected to a base of the first transistor, and a compensation transistor having a gate connected to a collector of the first transistor, a source and a back gate connected to the base of the first transistor and the bases of the plurality of second transistors, and a drain connected to a power source. The first transistor and the plurality of second transistors are bipolar transistors. The compensation transistor is a MOS-type transistor. A current corresponding to a current flowing in the first transistor is permitted to flow in the plurality of second transistors.

### TECHNICAL FIELD

The present invention relates to a current mirror circuit that includes a first transistor wherein a base and a collector are short-circuited and a second transistor wherein a base is connected to the base of the first transistor, and wherein a current corresponding to a current flowing in the first transistor is made to flow in the second transistor.

### BACKGROUND ART

Conventionally, a large number of current mirror circuits have been used in semiconductor integrated circuits, among known current mirror circuits are those illustrated in FIG. 1, FIG. 2, FIG. 3, and FIG. 4.

FIG. 1 shows a circuit using NPN-transistors, and FIG. 1(a) shows a constitution of a basic current mirror circuit.

The collector of the transistor Q1 is connected to a positive power supply via a current generator I, and the emitter is connected to the ground. Further, the collector of the transistor Q2 is connected to a positive power supply via a load M, and the emitter is connected to the ground. Then, the bases of the transistors (Q1, Q2) are directly connected to each other, and the base and the collector of the transistor Q1 are short-circuited. The constitution of FIG. 1(a) is a basic current mirror circuit, a current Iin from the current generator I becomes the base current of the transistors (Q1, Q2), and a current Iout equal to the current flowing in the transistor Q1 (or a size corresponding to the ratio of the emitter areas of the transistors (Q1, Q2)) flows in the transistor Q2.

FIG. 1(b) shows a Wilson current mirror circuit. The transistors (Q1, Q2) are respectively arranged between the emitters of transistors (Q3, Q4) and the ground, and the base and the emitter of the transistor Q3 are short-circuited. With this constitution, the base current of the transistors (Q3, Q4) is supplied from Iin, and the base current of the transistors (Q1, Q2) is supplied from Iout. Therefore, if the mirror ratio is 1, the influence of the base current can be removed to obtain Iin=Iout.

FIG. 1(c) shows a modified Wilson current mirror circuit. In this circuit, the transistor Q3 of FIG. 1(b) is omitted, and the base of the transistor Q4 is connect between the current generator I and the collector of the transistor Q1. Thus, the base current of the transistor Q4 is supplied from Iin, the base current of the transistors (Q1, Q2) is supplied from the transistor Q4, and compensation for up to the equivalent of the base current can be provided.

FIG. 1(d) is a circuit wherein a compensation transistor Q5 is provided instead of the short circuit between the base and the collector of the transistor Q1 of FIG. 1(a). In the compensation transistor Q5, a base is connected to the collector of the transistor Q1, a collector is connected to a positive power supply, and an emitter is connected to the bases of the transistors (Q1,Q2). Thus, the base current of the compensation transistor Q5 is supplied from the current Iin, but because the base current of the transistors (Q1, Q2) is supplied from the compensation transistor Q5, the amount of the base current flowing out from Iin can be made very small.

FIG. 1(e) is a circuit wherein a resistor R connecting the bases of the transistors (Q1, Q2) to the ground is provided in addition to the constitution of FIG. 1(d). This resistor can stabilize the base potential of the transistors (Q1, Q2).

FIG. 2 is a circuit wherein, in the configuration show in FIG. 1, each transistor is changed to a PNP-type and the current generator I and the load M are provided on the ground side. With these circuits, a current mirror circuit having a similar operation as in those illustrated in FIG. 1 can be obtained.

Furthermore, FIG. 3 shows a current mirror circuit wherein the transistors are N-channel MOS transistors, and FIG. 4 shows a current mirror circuit wherein the transistors are P-channel MOS transistors. These circuits can also provide a similar current flow.

Current mirror circuits are disclosed in JP No. 2006-33523A, JP No. 10-97332A, JP 7-121256A and the like, for example.

In the current mirror circuits in FIGS. 1 and 2 constituted of bipolar transistors, errors caused by base current inevitably arise in principle.

Specifically, in the circuits of FIG. 1(a) and FIG. 2(a), when the base current of the transistors (Q1, Q2) flows from Iin, the mirror ratio changes. Particularly, it is impossible to obtain sufficient accuracy when the hfe of the transistors is low or the mirror ratio is made larger. The circuits of FIGS. 1(b),(c) and FIGS. 2(b),(c) perform very well when the mirror ratio is 1:1. However, when an emitter area ratio between transistors is changed and the mirror ratio is a value other than 1:1, the base current cannot be offset, and the mirror ratio changes.

In the method of FIGS. 1(d),(e) and FIGS. 2(d),(e), because the base current of the transistors (Q1,Q2) can be supplied from the compensation transistor Q5, a current flowing out from Iin should only be the base current of the compensation transistor Q5, and the accuracy of the current mirror can therefore be significantly improved.

However, because a current having 1/hfe the collector current of the compensation transistor Q5 flows from Iin, this current.] often becomes a problem. Particularly, when a large number of output side transistors are provided to one transistor on a current mirror input side, the collector current of the compensation transistor Q5 becomes larger and the influence on Iin increases.

Although the current mirror circuits of FIGS. 3 and 4 constituted by MOS transistors do not employ a base current, the uniformity of the MOS transistors is inferior to that of a bipolar transistor. Therefore, it is necessary to increase transistor size in order to achieve equal performance, which creates problems of frequency characteristic degradation, increased cost, or larger size caused by degradation in the degree of integration. Furthermore, because the threshold voltage Vgs of the MOS transistor is larger than the threshold voltage Vbe of the bipolar transistor, a large dynamic range cannot be ensured, and it is difficult to apply MOS trangistors to a circuit having low power supply voltage.

### DISCLOSURE OF THE INVENTION

A current mirror circuit according to the present invention includes a first transistor wherein a base and a collector are short-circuited, and a second transistor wherein a base is connected to the base of the first transistor, and a current corresponding to a current flowing in the first transistor is permitted to flow in the second transistor. The circuit further comprises a compensation transistor wherein a gate is connected to the collector of the first transistor, a source is connected to the bases of the first and second transistors, and a drain is connected to a power source. The first and second transistors are bipolar transistors, and the compensation transistors are MOS-type transistors.

Because an MOS-type transistor is used as the compensation transistor, a base current is not required for the compensation transistor, but a highly accurate current mirror circuit can be obtained.

### BRIEF DESCRIPTION OF THE DRAWINGS

FIG. 1 is a view showing the basic constitution of a current mirror circuit.

FIG. 2 is a view showing the basic constitution of another current mirror circuit.

FIG. 3 is a view showing a basic constitution of still another current mirror circuit.

FIG. 4 is a view showing a basic constitution of still another current mirror circuit.

FIG. 5 is a view showing the constitution of a current mirror circuit according to an embodiment of the present invention.

FIG. 6 is a view showing the constitution of a current mirror circuit according to another embodiment of the present invention.

FIG. 7 is a view showing the constitution of a current mirror circuit corresponding to the embodiment of FIG. 5 and having a plurality of outputs.

FIG. 8 is a view showing the constitution of a current mirror circuit having a plurality of outputs and corresponding to the embodiment of FIG. 6 and having a plurality of outputs.

### BEST MODE FOR CARRYING OUT THE INVENTION

Hereinafter, embodiments of the present invention will be described based on the drawings.

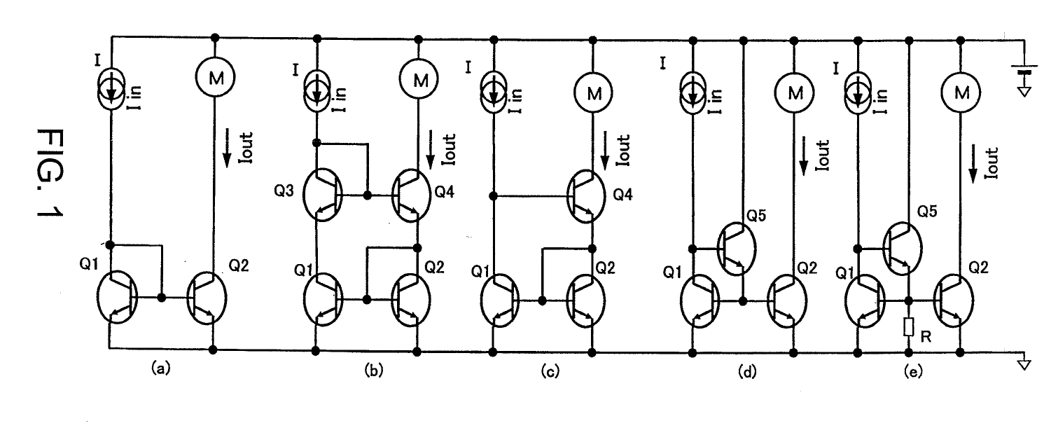

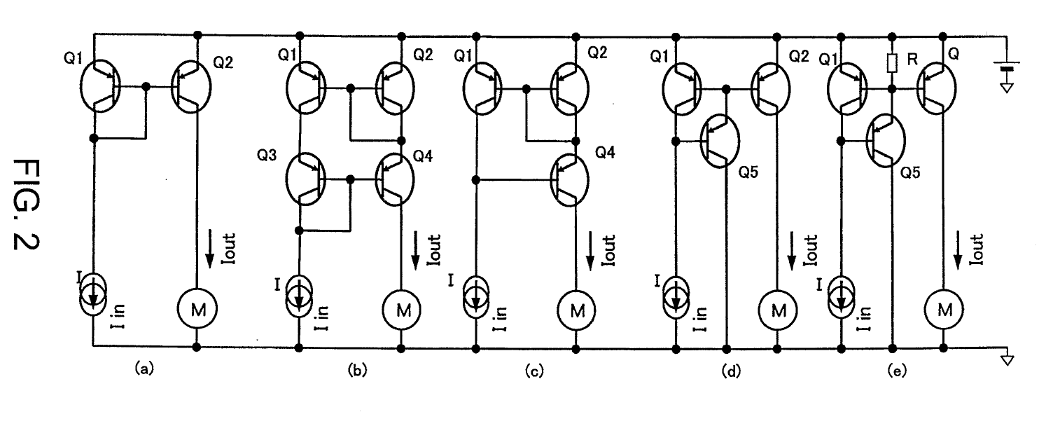

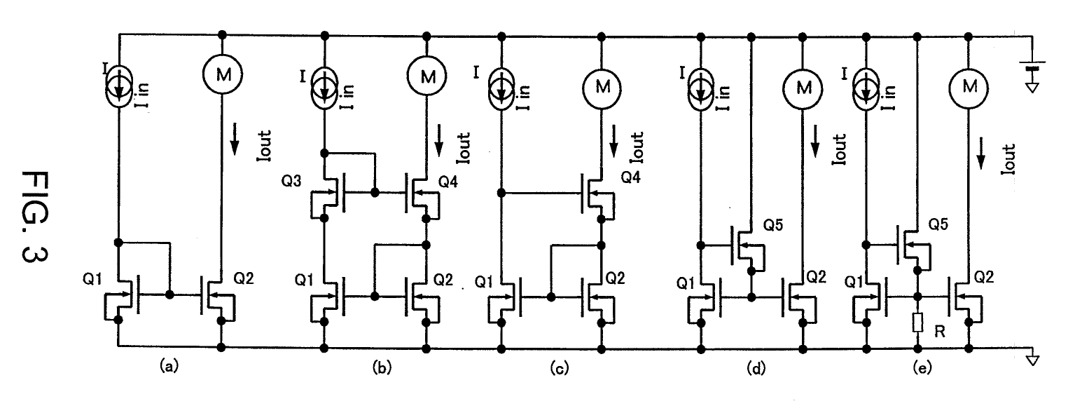

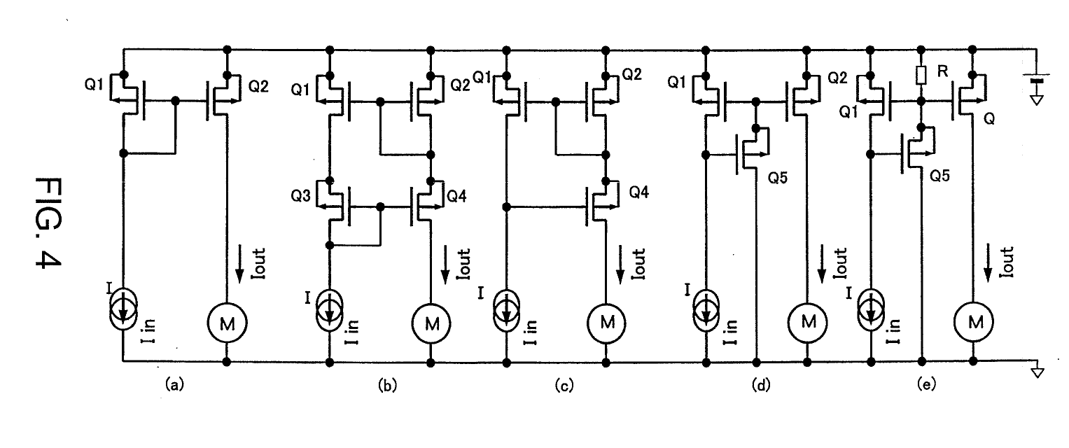

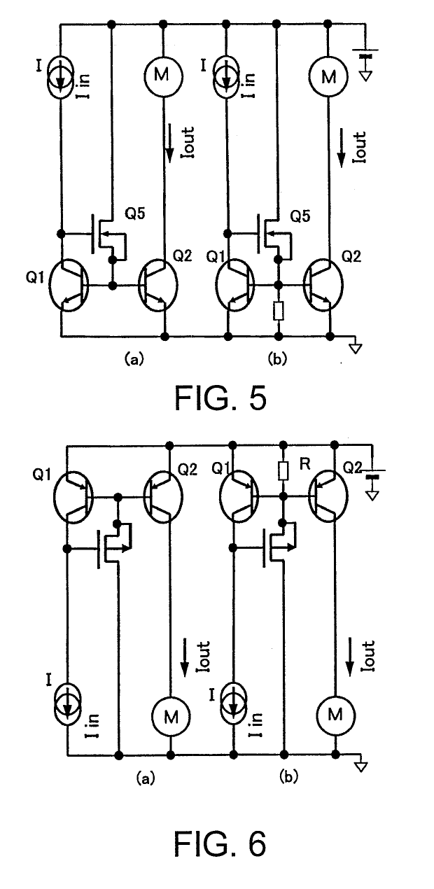

FIG. 5 shows a constitution of one embodiment. The current mirror circuit of FIG. 5(a) has a constitution corresponding to (d) in FIGS. 1 to 4.

The collector of a bipolar NPN-type transistor Q1 is connected to a positive power supply via a current generator I, and the emitter is connected to ground. Further, the collector of a bipolar NPN-type transistor Q2 is connected to the positive power supply via a load M, and the emitter is connected to ground. Further, the bases of the transistors (Q1,Q2) are directly connected to each other. Then, the circuit has an N-channel MOS-type compensation transistor Q5, in which the gate of the compensation transistor Q5 is connected to the collector of the transistor Q1, the drain is connected to the positive power supply, and the source is connected to the bases of the transistors (Q1,Q2).

Thus, the base current of the transistors (Q1,Q2) is supplied from the compensation transistor Q5. The compensation transistor Q5 is a MOS-type transistor which does not require a base current and can prevent degradation of the mirror ratio caused by the base current.

On the other hand, both the transistor Q1 that permits the current Iin flowing in the current generator I to flow and the transistor Q2 that constitutes the current mirror circuit together with the transistor are bipolar transistors having good uniformity (pairness), and the base current supplied to a common base of the transistors (Q1, Q2) is distributed on a set mirror ratio. Because Iin flows directly in the transistor Q1, a current Iout obtained by multiplying the Iin by the mirror ratio flows in the transistor Q2, and a highly accurate current mirror circuit is obtained.

FIG. 5(b) shows a current mirror circuit having a constitution corresponding to (d) in FIGS. 1 to 4. Specifically, a resistor R is arranged between the common base of the transistors (Q1, Q2) and the ground. In such a constitution, similarly to the above-described example, the current Iout is also obtained by multiplying the Iin flowing in the transistor Q1 by the mirror ratio can be made to flow in the transistor Q2 with good accuracy.

Next, and example operation of a circuit as shown in FIG. 5 will be described.

First, before the power source starts operation, all of the transistors (Q1, Q2, Q3) are OFF. Once the power source is turned ON to build up a power supply voltage, the current Iin from the current generator I is applied first to the collector of the transistor Q1 and the gate of the transistor Q2. However, because the transistors (Q1, Q5) are originally OFF and have high impedance, the collector of the transistor Q1 and the gate of the transistor Q2 rise from 0V, and a bias is applied to Vbe of the transistors (Q1,Q2) and Vgs of Q5.

When the gate of Q5 and the collector of Q1 increase to a threshold voltage, the compensation transistor Q5 is turned ON to supply a base current Ib to the transistor Q1 and the transistor Q2. Because the compensation transistor Q5 is a MOS-type transistor which does not have a base current Ib and which does not influence the current flowing in the transistor Q1, the current Iin flows directly the transistor Q1.

Meanwhile, in the current mirror circuit shown in FIG. 5(b), although a portion of the current from the compensation transistor Q5 flows to the ground via a resistor R, the overall operation is basically the same.

Furthermore, FIGS. 6(a),(b) show a constitution in which the transistors (Q1, Q2) are PNP transistors and the compensation transistor Q5 is a P-channel transistor in circuit of FIGS. 5(a),(b). In this constitution as well, an operational effect basically similar to that provided by the current mirror circuit shown in FIGS. 5(a),(b) can be obtained.

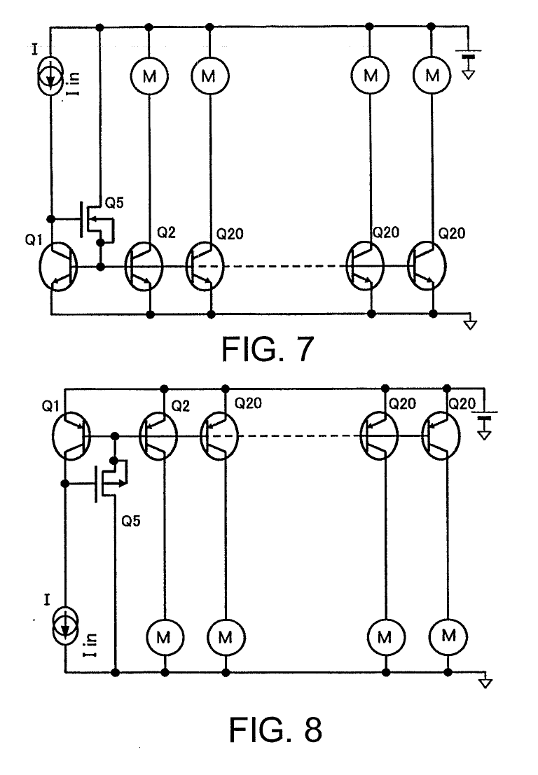

FIG. 7 shows a constitution wherein a plurality of transistors on the current mirror output side are provided to one transistor on the current mirror input side and the compensation transistor. In this constitution as well, a sufficient base current can be supplied from the MOS-type compensation transistor Q5, and the base current is not in the compensation transistor Q5. It should be noted that FIG. 6 uses NPN-type and N-channel type transistors as transistors that constitute the current mirror.

FIG. 8 shows a constitution in which PNP-type and P-channel type transistors are used instead of the NPN-type and N-channel type transistors in the constitution of FIG. 7.

As described, the following effects are obtained by the current mirror circuit of the present invention:
(i) A circuit is relatively is simple.
(ii) Only the compensation transistor Q5 is a MOS-type transistor, the compensation transistor Q5 only supplies a base current corresponding to the collector current of the transistor Q1 to the transistors (Q1,Q2), does not have a problem in performance, and an area can be made relatively small.
(iii) By determining the current Iin of the current generator I, the current Iout is determined corresponding to the current Iin, and for this reason, a circuit basic having a superior temperature characteristic is obtained.
(iv) Even when a large number of transistors on the current mirror output side are connected, no problem occurs as long as the current capability of the compensation transistor Q5 is sufficient, and a high performance mirror ratio can be maintained.

Although the circuits shown in each of (a) to (e) in FIG. 1 to FIG. 4 and (a) and (b) in FIG. 5 and FIG. 6 are all connected to a common ground and a main power source, the circuits in each drawing are separate circuits.

1. A current mirror circuit comprising:
a first transistor;
a plurality of second transistors whose bases are connected to a base of the first transistor; and
a compensation transistor having a gate connected to a collector of the first transistor, a source and a back gate connected to the base of the first transistor and the bases of the plurality of second transistors, and a drain connected to a power source, wherein
the first transistor and the plurality of second transistors are bipolar transistors, the compensation transistor is a MOS-type transistor, and
a current corresponding to a current flowing in the first transistor is permitted to flow in the plurality of second transistors.

2. The current mirror circuit according to claim 1, wherein
the first transistor and the plurality of second transistors are NPN-type transistors,
the compensation transistor is an N-channel type transistor, and
the power source to which the drain of the compensation transistor is connected is a positive power supply.

3. The current mirror circuit according to claim 1, wherein
the first transistor and the plurality of second transistors are PNP-type transistors,
the compensation transistor is a P-channel type transistor, and
the power source to which the drain of the compensation transistor is connected is a negative power supply.
